(19) United States
(12) Patent Application Publication
(10) Pub. No.: US 2007/0127393 A1
(43) Pub. Date: Jun. 7, 2007

(54) Device and method for setting up ad hoc networks

(75) Inventor: Christian Car, Hamburg (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: 4G Systems GmbH, Hamburg (DE)

(21) Appl. No.: 10/579,671

(22) PCT Filed: Jul. 23, 2004
(86) PCT No.: PCT/EP04/08216

§ 371 Date: Jan. 29, 2007

(30) Foreign Application Priority Data
Nov. 18, 2003 (DE) 103 53 851.8

(51) Int. Cl. H04L 12/28; H04L 12/56

(52) U.S. Cl. 370/254; 370/400

(57) ABSTRACT

The invention concerns a network element (1) for setting up wireless networks (3), a corresponding network (4) and a method of setting up wireless networks and of wireless data exchange between network elements (1) and/or network users (2), wherein the network element (1) has a transmitting/receiving unit (12) for wirelessly transmitting and receiving data, a control unit (11) for controlling the processing of data and a data memory (15). For improving known concepts for setting up wireless networks the control unit (11) is adapted to evaluate connection path information (22) and connection state information (21) for data exchange between network elements (1) and/or network users (2) in order to determine partial sections of data transmission routes and/or complete data transmission routes for transmitting or forwarding data, wherein the connection path information (22) specifies the number of the network elements (1) and the neighbourhood relationships of the network elements (1) of the network and the connection state information (21) specifies the state of the connection between network elements (1) and/or network users (2).

The invention concerns a network element for setting up wireless networks for wireless data exchange between network elements and network users, wherein the network element has a transmitting/receiving unit for wirelessly transmitting and receiving data, a control unit for controlling the processing of data and a data memory. The invention also concerns a method of setting up wireless networks for data exchange between network elements and network users and a network having network elements for setting up wireless networks for network users.

Wireless networks (wireless local area networks=WLANs) are increasingly coming into use. In that respect so-called network elements serve in particular as cableless access points for mobile network users (laptop users with a WLAN card). The number of network users per network element is limited as otherwise the data transmission rate per network user is excessively low. A network element covers only a very limited space for cableless network access (radius of about 300 m), and that is only if there is a direct line-of-sight connection between the network element and the mobile network user.

A conventional network element serves as a cableless interface to the Internet. The connection to the Internet is provided by an Internet service provider. That therefore gives a point-to-multipoint network topology which covers a spatially very severely restricted area with cableless network access and is of use only for mobile network users with direct line-of-sight connection. In the event of failure of the network elements, network access is no longer possible, that is to say the system is not fail-safe. Also, upon failure of the Internet connection of the Internet service provider, there is no failure protection for the network user as that represents the sole access point to the Internet.

In addition an expansion of the spatial coverage with cableless network access is possible only with a limited number of conventional network elements (by means of what is referred to as WDS technology; the limit is at about 8 through 10 conventional network elements in order to achieve an increase in spatial coverage).

The object of the invention is to provide a network element, a network and a method directed thereto, which affords a more far-reaching, more easily available and more convenient network access, improved network access options for mobile network users and improved network properties.

In accordance with the invention in a network element of the kind set forth in the opening part of this specification that object is attained in that the control unit is adapted to evaluate connection path information and connection state information for data exchange between network elements and/or network users in order to determine partial sections of data transmission routes or complete data transmission routes for transmitting or forwarding data, wherein the connection path information specifies the number of the network elements and the neighbourhood relationships of the network elements of the network and the connection state information specifies the state of the connection between network elements and network users.

In accordance with the invention the object is further attained by a method of the kind set forth in the opening part of this specification, comprising the steps: exchanging and storing connection path information and connection state information of the network elements relative to each other and of the network users relative to the network elements, evaluating the connection path information and connection state information, exchanging data between network elements and network users based on the items of connection path information and items of connection state information, by despatching data through a first network user to a network element arranged in the proximity, and receiving the data through the network element and further despatching the data in relation to an adjacent network element in a direction towards the addressed second network user or the addressed network user itself by way of a data transmission route ascertained from the connection state and connection path information or a partial section of a data transmission route.

In accordance with the invention the object is also attained by a network of the kind set forth in the opening part of this specification, with network elements according to the invention for setting up wireless networks for network users according to a method according to the invention, wherein the data exchange between two or more network users is always effected at least by means of a network element and on the basis of the connection state and the connection path information.

The method according to the invention affords numerous advantages. The ongoing exchange of items of information about the state of the network is particularly desirable. In that respect the data from network elements which are further away are always passed on by transfer to adjacent network elements and each network element supplements the items of information until each network element carries the entire information corresponding to the complete topology of the network. In that way each network element can on its own account calculate directly a route through the network. That affords optimum decentrality. The computing capacity is not exhausted centrally but always at the location at which the data to be transmitted just are. Those advantages are made possible and further enhanced by the above-mentioned properties and features of the network element according to the invention.

Data in the sense of this application and in the sense of the claims include any form of data and/or information, in particular control, video, audio, synchronisation, initialisation, error correction, error recognition, modulation and encoding information or data, to give just some examples, and all other items of information and data.

The term neighbourhood ratio in the sense of this application is used to mean the existence, the state or nature, the quantity and the quality of the data communication channels of network elements according to the invention relative to each other. A neighbourhood ratio can be afforded on the basis of the spatial arrangement, but is not restricted thereto. In particular network elements can also be in neighbouring relationship in the sense of this application if one or more further network elements are arranged spatially between them. The aspect in the foreground is the possibility of being able to construct an electromagnetic connection. A neighbourhood ratio can therefore also alter due to interference influences.

Connection state information is used to denote all qualitative features of one or more connections, in particular also over a prolonged period of time. That can include the spatial distances, the quality of the connection measured as signal-noise ratio (SNR) and much more.

Large-area networks can be set up with the network element according to the invention without involving complicated and expensive infrastructure measures. Upon activation the network elements according to the invention form a flexible and decentral network which organises itself and which guarantees a very high level of security and availability. That is the crucial step from the decentral network element to the area-coverage network access zone.

The network element according to the invention is far superior to the conventional WLAN solutions not only from a technical point of view but also from a commercial and economic point of view. In comparison with previous solutions for affording a network infrastructure, the costs of building up and extending a network access zone of any size are reduced. The self-organisation aspect of the network and the fact that further wiring measures are almost completely dispensed with make it possible to implement drastic cost savings. The flexible and decentral structure of a network access zone makes it possible to expand the network in terms of area and power by simply adding further network elements according to the invention. It is thus possible to almost completely dispense with planning of the network and expensive infrastructure measures.

Preferably the control unit is adapted to evaluate connection state information and connection path information stored in the data memory and selectively or simultaneously connection state information and connection path information contained in the data intended for the data exchange. In that way the network element can combine data which only occur in the transmission of the data, for example how many so-called hops (jumps between network elements) have already taken place, with the items of information in the network element, and calculate therefrom a route which is still favorable, or experience something new in respect of the network topology. Expressed in imagery terms, that is as if a traveller were to report on his journey or the region travelled.

It is also advantageous if the connection path information stored in the data memory specifies the number of the network elements and the neighbourhood relationships of the network elements of the entire network and the connection state information specifies the state of the connection between network elements and network users of the entire network. Accordingly each network element has or receives all necessary items of information for calculating a complete data transmission route through the network and is thus completely autonomous.

Preferably the network element according to the invention has data memories with an item of authentication information which is present only a single time for each network element and which is stored in a fixed data memory and the control units are adapted to transmit the authentication information by means of the transmitting/receiving units to other network elements and to evaluate the items of authentication information sent from other network elements for checking the entitlement of the other network elements of the network for data exchange in the network. That ensures maximum security for data transmission in the network. Checking of entitlement (for example a certificate from a certification authority) is effected automatically by the network elements according to the invention themselves. That means that no such measures are required by the user when setting up the network.

Preferably the data memory of a network element according to the invention has a unique item of authorisation information, in particular an item of address information, which is characterising in respect of each network user and each network element in the network, and the control unit is adapted to transmit the authorisation information by means of the transmitting/receiving units to other network elements and to evaluate the authorisation information sent from other network elements to determine data transmission routes or partial sections of data transmission routes in the network. That permits what is referred to as ‘roaming’ of network users through the network consisting of network elements according to the invention. The network user always has the same address within the network by way of which data exchange is implemented with him. For the network user, the network also always has the same address. The network user can thus move from one network element to another and can continuously receive and transmit data.

Preferably the network element has a first transmitting/receiving unit for the data exchange of network elements with each other and a second transmitting/receiving unit for data exchange between network elements and network users. In that way the data for communication between network users and network elements are processed separately from each other. The resources (bandwidth, radio channels) are preserved and carefully husbanded and data transmission takes place more quickly, more smoothly and more reliably.

Preferably coupling means for coupling the network element for data exchange with a second network, in particular a non-wireless infrastructure network like the Internet are arranged on a network element according to the invention. That permits access to the infrastructure network by means of each network element according to the invention. In combination with the above-specified advantages, that affords completely new and improved possible options for network users in terms of access to a second network. The bottlenecks of existing concepts can be overcome with the network according to the invention because practically any unlimited number of network elements according to the invention can be assembled to constitute a network.

Preferably the network element according to the invention, for a supply with electrical energy, has coupling means for coupling to a plurality of different energy sources, in particular solar cells. That arrangement provides that the network element according to the invention can achieve maximum autonomous operation and is independent of individual energy suppliers.

It is further preferred that the network element according to the invention can also be supplied with energy by means of the coupling means for data exchange for a non-wireless infrastructure network, in particular an Ethernet connection. That eliminates the need for a further wired connection.

It is further preferred if the transmitting/receiving units are in accordance with one or more of the standards IEEE 802.11a, IEEE 802.11b, and IEEE 802.11g.

Preferably the network element according to the invention also has one or more WLAN PCI-cards in accordance with one or more of the standards IEEE 802.11a, IEEE 802.11b, and IEEE 802.11g, volatile and non-volatile memories, in particular SDRAMs or flash memories, a microprocessor or microcomputer unit or programmable logic components for regulating and controlling power loss and the energy sources and two antennae respectively for data from network users and/or network elements.

In addition a preferred method step according to the invention for setting up an ad hoc network lies in finding network elements and network users by wirelessly receiving and emitting connection enquiries, as well as further steps in checking the authenticity of the found network elements by evaluation of a sent item of authenticity information for ascertaining the entitlement for data exchange and storage of the entitlement information ascertained therefrom and transmitting, receiving, allocating and storing in the network unique authorisation information, in particular address information of network elements and network users. That provides for reliable, interruption-free data transmission and a direct connection between network users even if they are moving in the network.

Advantageously network users are handed over from the transmitting/receiving region of a first network element into the transmitting/receiving region of a second network element in dependence on the connection state information and the connection path information while retaining the unique authorisation information allocated to the network user. That provides that the network users enjoy optimum capacities for communication and optimum freedom of movement in the network.

Preferably the handover of a network user from a first network element to a second network element is implemented by the provision of a predefined limited number of items of authorisation information for network users, which is the same in all network elements, the detection of an association event by a network element, which indicates that a network user is within the transmission/reception range of a network element, comparison of the communicated authorisation information with the predefined known items of authorisation information, evaluation of the comparison to ascertain whether this is an external network user or a network user who is already known, assignment of an item of authorisation information when an external network user has been ascertained, communicating the connection path and/or connection state information related to the network user to the network elements of the network and communicating an item of authorisation information to the network user, which is characteristic of the network, in particular address information for data transmission.

Preferably network elements are added into the transmitting/receiving regions or the network access zone of the network elements already arranged in the network to increase the data transmission rates of connection paths and to improve the fail-safe aspect of the network. That affords a high level of redundancy in the network. The transmission rates can be increased. If a network element according to the invention fails the connection can be taken over by a close network element.

A preferred feature also provides for separation of the wireless data exchange in accordance with network users and network elements, in particular by using different frequency ranges, allocating frequency channels, time multiplexing and/or different modulation methods and/or standards in respect of wireless data transmission for the data exchange between network users and the data exchange only between network elements for the purposes of increasing the data processing speed of the network.

The data transmission rate and data transmission reliability and security are increased by preferably coupling a plurality of network elements to a second network, in particular a non-wireless infrastructure network such as the Internet.

A network according to the invention has network elements according to the invention as set forth in one of claims 1 through 11 and a method as set forth in one of claims 12 through 20, wherein the data exchange between two or more network users is always effected at least by means of a network element and on the basis of the connection state and connection path information of the network elements.

Further advantageous configurations are set forth in the appendant claims.

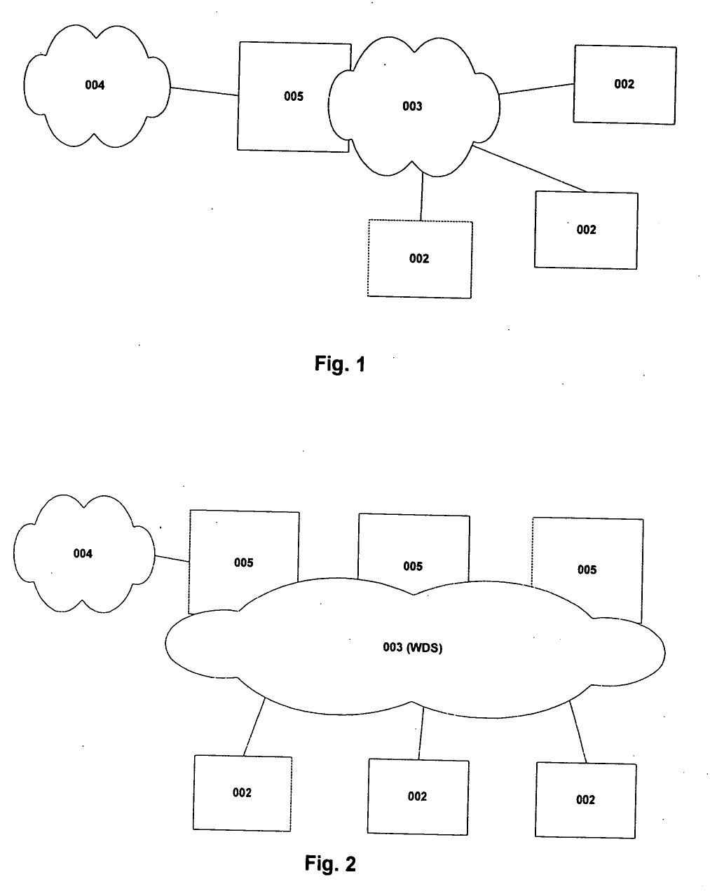

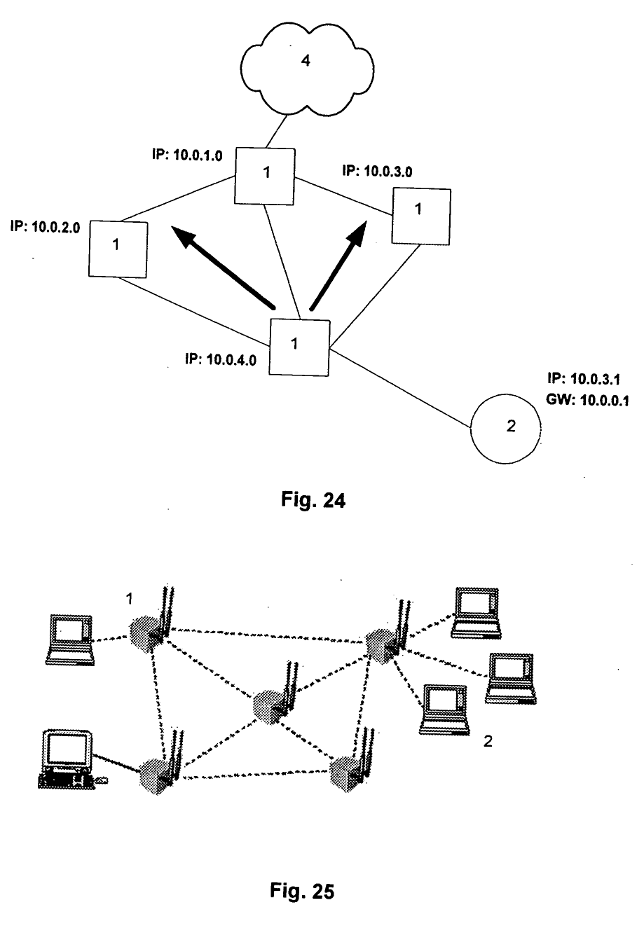

An embodiment by way of example of the network element according to the invention, the network according to the invention and the method according to the invention of setting up a network according to the invention are described in detail with references to FIGS. 1 through 28 in which:

FIG. 1 is a diagrammatic view of a conventional network,

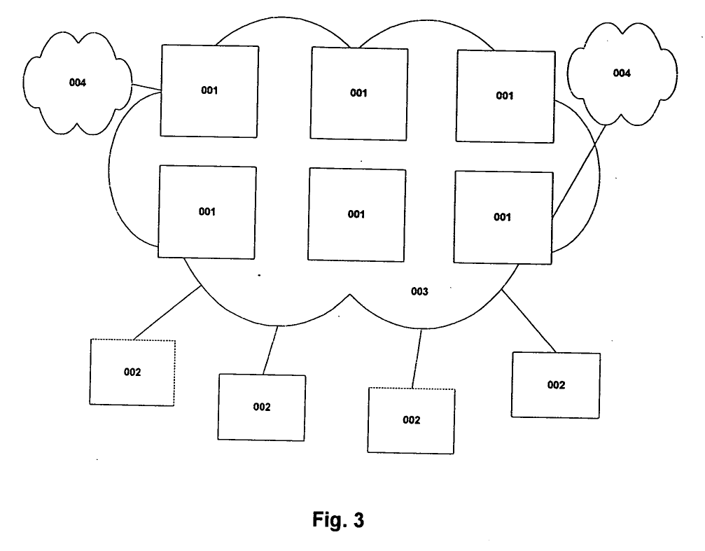

FIG. 2 is a diagrammatic view of a conventional network using WDS technology,

FIG. 3 is a diagrammatic view of a network according to the invention with network elements according to the invention,

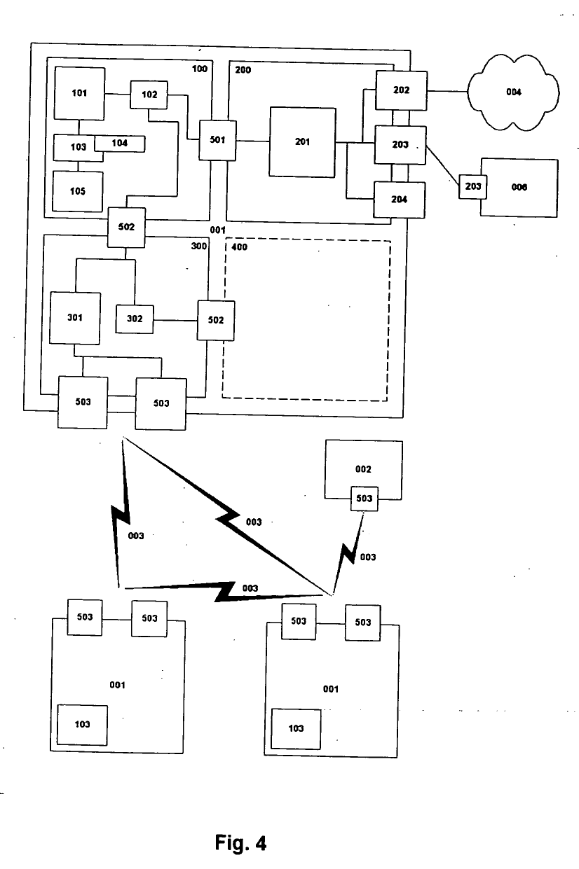

FIG. 4 is a diagrammatic view of a network according to the invention and network elements according to the invention on a more detailed scale,

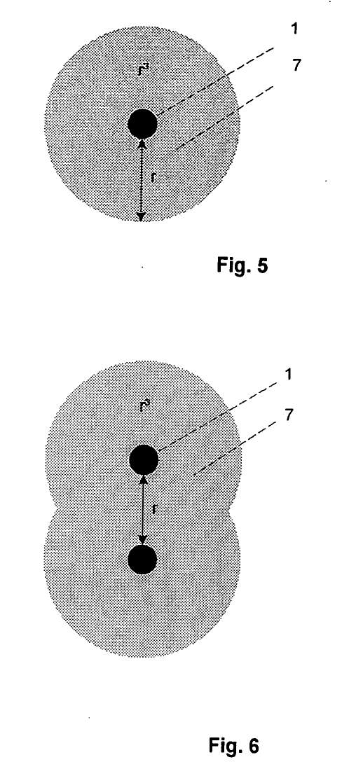

FIG. 5 is a diagrammatic view of a network according to the invention and the associated network access zone,

FIG. 6 is a diagrammatic view of two network elements according to the invention and the associated network access zone,

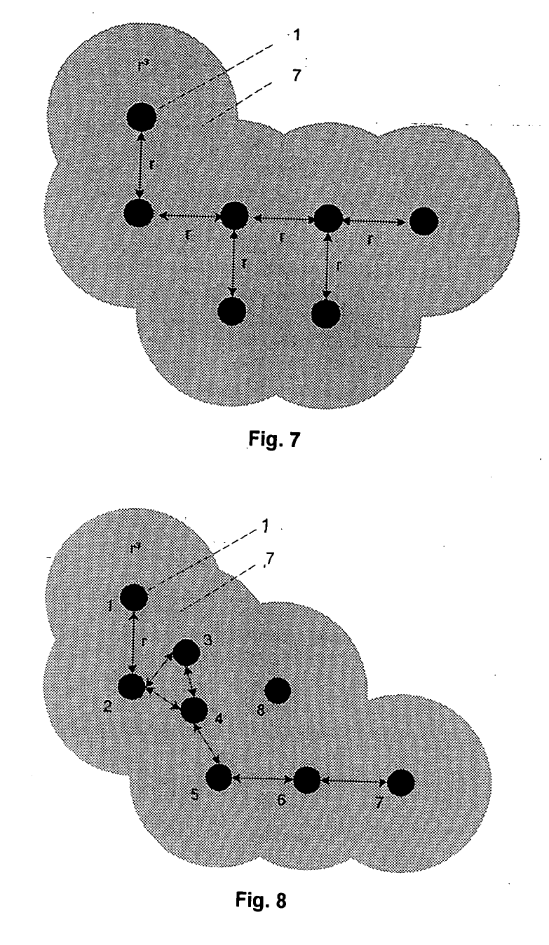

FIG. 7 is a diagrammatic view of seven network elements according to the invention and the associated network access zone,

FIG. 8 is a realistic scenario in diagrammatic form of a network according to the invention,

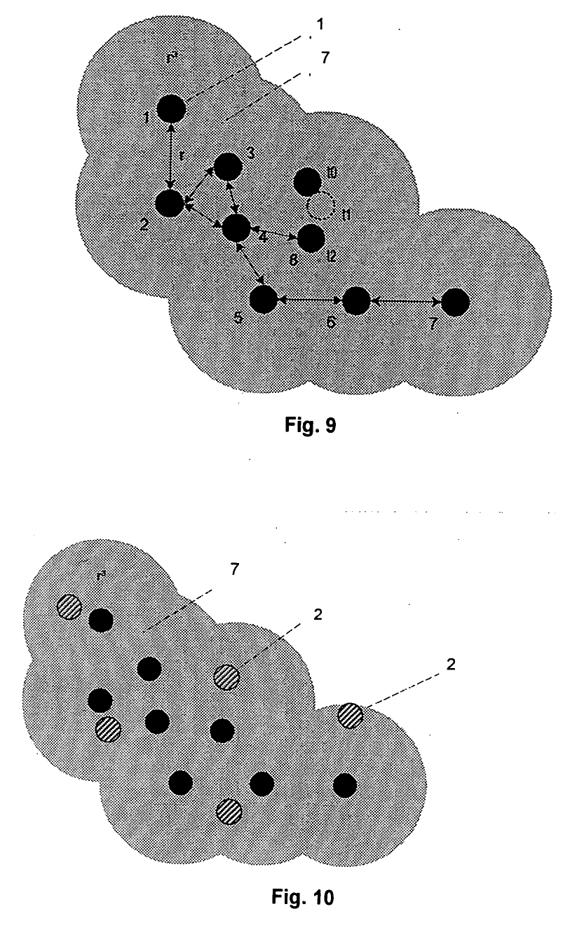

FIG. 9 is a diagrammatic view of a transit time model of a network according to the invention,

FIG. 10 is a diagrammatic view of a static model of a network according to the invention,

FIG. 11 is a further diagrammatic view of the static model of FIG. 10,

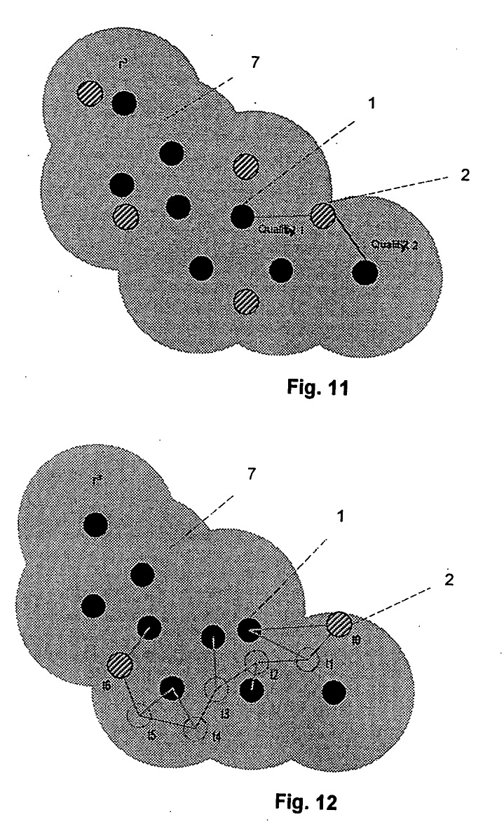

FIG. 12 is a diagrammatic view of a dynamic model of a network according to the invention,

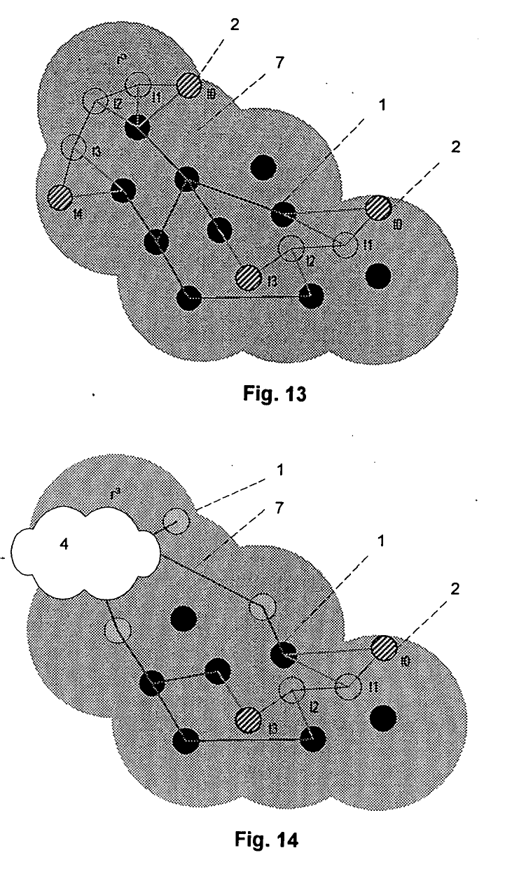

FIG. 13 is a diagrammatic view of the data communication between two network users in a network according to the invention,

FIG. 14 is a diagrammatic view of the communication of network users with an infrastructure net in a network according to the invention,

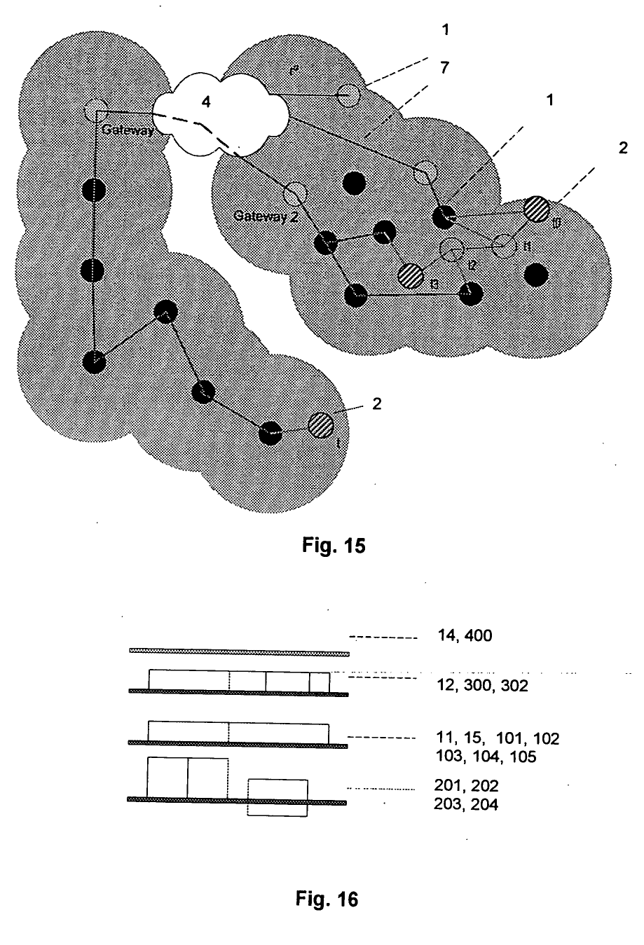

FIG. 15 is a diagrammatic view of the communication of two networks according to the invention connected by an infrastructure network and two network users,

FIG. 16 is a diagrammatic view of the hardware structure of a network element according to the invention,

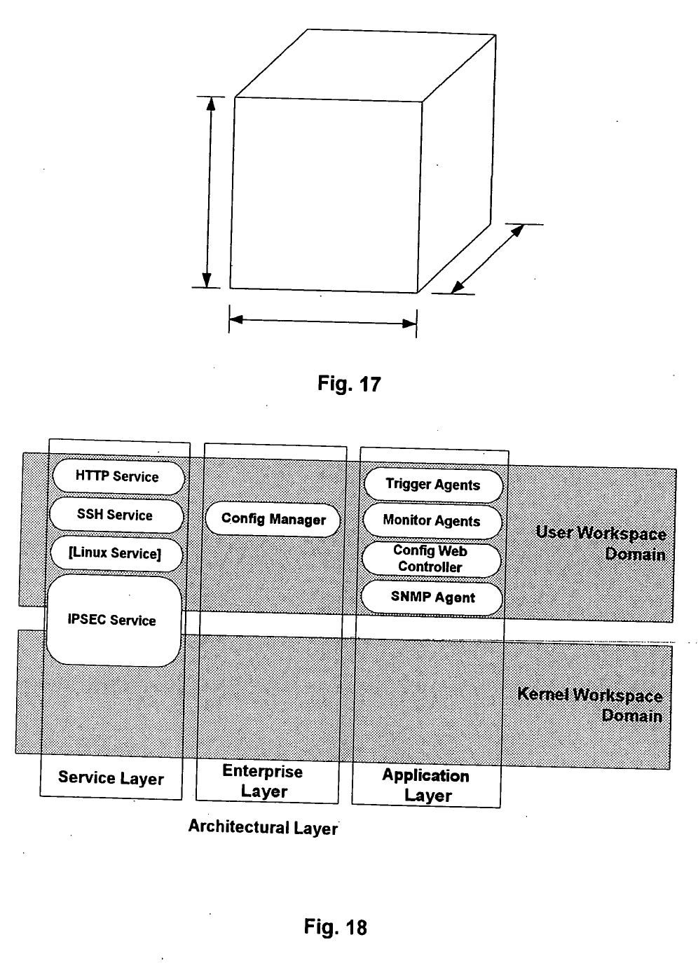

FIG. 17 is a diagrammatic view of the typical external housing shape of a network element according to the invention,

FIG. 18 is a diagrammatic view of the architecture of a computer program for a network element according to the invention,

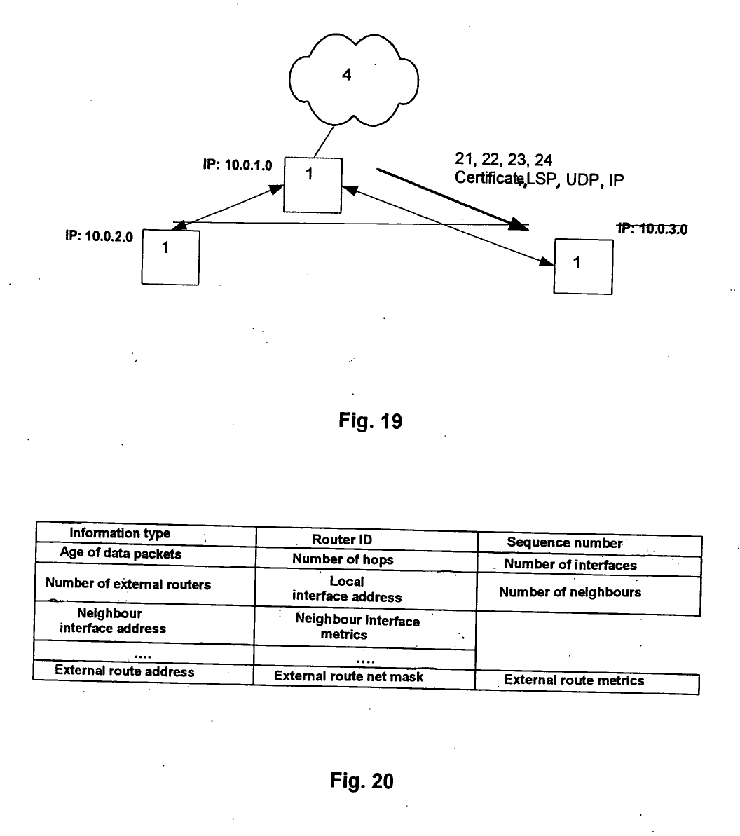

FIG. 19 is a diagrammatic view of the link discovery protocol and link state protocol in a network according to the invention,

FIG. 20 shows a data architecture in the link state protocol for network elements of a network according to the invention,

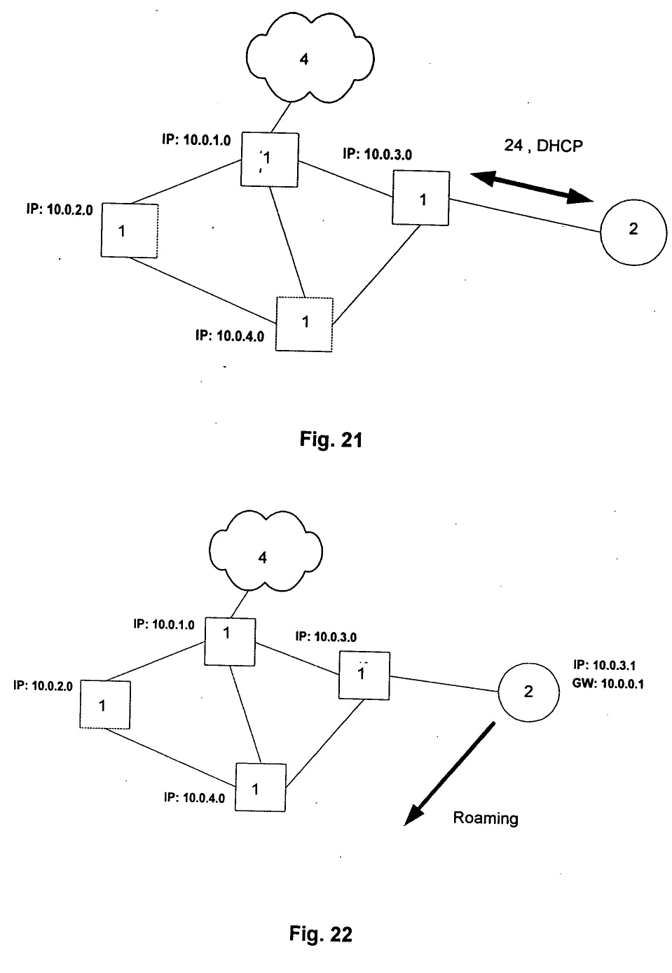

FIGS. 21 through 24 are diagrammatic views of a roaming process of a network user in a network according to the invention,

FIG. 25 is a multipoint-to-multipoint connection in a network according to the invention,

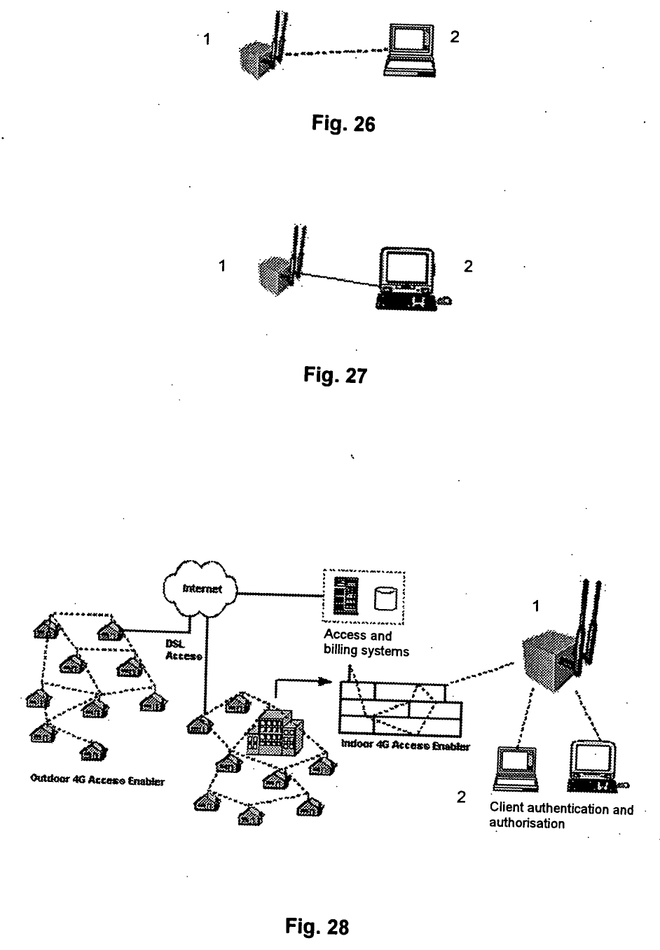

FIG. 26 is a figurative view of a hotspot,

FIG. 27 is a figurative view of the network element according to the invention in the form of a WLAN adaptor, and

FIG. 28 is a comprehensive view of the options of use and application of the network element according to the invention and the network according to the invention.

FIG. 1 represents the scenario which is involved when using commercially available network elements 5. That scenario is also referred to as a ‘hotspot’. A hotspot is a spatially limited region in which cableless WLAN access (WLAN network, 3) is possible for network users 2. The conventional network element 5 is connected to the Internet 4 by means of an interface. The conventional network element 5 produces a spatially limited region of the cableless network access 3. In that region, it is possible for network users 2 to have cableless access to the network or to the Internet 4. Network users are devices such as for example laptops or PDAs (personal digital assistants) provided with a WLAN interface which is compatible with the respective standard used by the WLAN 3 (IEEE 802.11b, IEEE 802.11g and IEEE 802.11a). A cableless network access outside the network 3 is not possible.

FIG. 2 expands the representation of the functionality of FIG. 1 in respect of spatial coverage of the network 3. By means of commercially available network elements 5 with WDS functionality (WDS—wireless distribution system) it is possible to combine together up to 10 network elements 5 and thus to increase the spatial extent of the network 3. The WDS functionality corresponds to a cableless bridge between the network elements 5. In that respect the network elements 5 are configured as a bridge. A network element 5 is configured in that respect as a gateway to the network or Internet. Achieving a larger number of network elements 5 and thus a greater spatial coverage with the network 3 is to be implemented only by means of additional installation expenditure by adding cabled network connections and additional devices. That considerably limits the installation options in respect of the network elements 5 as the cabled network infrastructure required for that purpose is not available at most locations for setting up hotspot. Network users 2 are enabled to achieve cableless access to the network or Internet 4 within that network 3.

FIG. 3 shows the use of the network element 1 according to the invention (also 4G Access Cube™ or 4G Access Enabler) in a network 3 according to the invention and the possibility linked thereto of unlimitedly spatially extending the network 3 according to the invention by the addition of additional elements 1 according to the invention. In that respect manual configuration of the network element 1 according to the invention is not required as the network elements according to the invention automatically implement configuration. The operating mode of the network element 1 according to the invention (‘operation mode’) is selected automatically. In addition there is no need for a cabled infrastructure for the spatial extension of the network 3 according to the invention; the network 3 between the network elements 1 according to the invention is formed completely cablelessly and independently; the network 3 is expanded by simply adding network elements 1 according to the invention in spatial proximity (within the network access zone) in relation to a network element 1 according to the invention.

A plurality of network accesses or accesses to the Internet 4 are also possible, that is to say when a network connection 4 breaks down the connection 4 which is spatially most closely adjacent is automatically selected. That has no influence on the network users 2; the change takes place completely transparently in the background.

It is made possible for network users 2 to acquire cableless access to the network or the Internet 4 within that WLAN 3.

FIG. 4 shows three network elements 1 according to the invention, two network users 2, a network access to the Internet 4 and the subcomponents thereof including interactions. A network element 1 according to the invention comprises a logic board 100, an IO board 200, two WLAN boards 300 and optionally one or more extension boards 400. The boards are physically connected together by a hardware interface 501, 502—a plug connection. The interface 502 is that interface which is used as a plug interface for adding extension boards 400 (for instance for flash memory expansions, graphic cards etc). In that respect any number of extension boards 400 can be ‘stacked’ by means of the interface 502.

The logic board 100 comprises a CPU 101 which loads program instructions 104 stored in the flash memory 103 into the RAM 105 and executes them. The program instructions essentially comprise an operating system and algorithms which permit appropriate functionality of the system according to the invention. In addition the controller 102 takes over management of the logic board such as for example communication to the exterior by way of the interfaces 501 and 502. The IO board 200 includes the cabled interfaces to the exterior: Ethernet 202, USB 203 and power connection 204. Optionally the power supply can also be implemented by way of the Ethernet interface 202 (by means of PoE—power over Ethernet standard, IEEE 802.3af, which provides separate data and power transmission by way of an Ethernet cable). In the usual case the Ethernet interface 202 is used for the network connection on to the Internet 4. The USB interface 203 permits the connection of external devices such as for example USB memory devices. In addition it is possible to use the network element 1 according to the invention as a so-called network adaptor in order for example to connect PCs 6 by way of the USB interface 203 and to permit access to networks 3. The controller 201 provides for automatic recognition as to whether for example the power supply is effected by way of the power connection 204 or alternatively by way of the Ethernet interface 202.

The WLAN board 300 is connected to the logic board 100 by way of the interface 502. In that case a controller 302 performs the task of controlling any additional extension board 400 which is connected to the WLAN board 300 by means of the interface 502. The WLAN transceiver 301 provides for secure and reliable despatch and reception of data packets by way of the network 3. Separate transmitting and receiving antennae 503 increase the data throughput of the data packets by way of the network 3.

The network according to the invention represents far-reaching surface coverage with cableless network access based on one of the IEEE 802.11 standards. The system has a very high level of fail-safe due to redundancy of the network connections and due to self-organisation of the entire network. The problem of the lack of line-of-sight connection between access point and network users, caused by what are referred to as ‘radio shadows’, is overcome by strategic positioning of the access points and the self-organisation thereof.

The system comprises a plurality of network elements of the same design, which are connected together by a cableless interface for data transmission. The cableless interface additionally also connects mobile network users to the devices.

The device in itself comprises a hardware part and a software part. The hardware comprises an IO part, a logic part and a WLAN part.

The IO part represents the interface for regular operation of the device. It includes a connection for the power supply, an Ethernet connection (which can be used for the cabled network connection or in addition by PoE—power over Ethernet—as an alternative power supply) and two USB connections (USB host and USB device) for the operation of external devices such as for example sound cards, memory modules, webcams etc.

The WLAN part permits cableless data communication of the devices of the overall system and in addition provides for cableless connection of the network users. The WLAN part can alternatively comprise one or more cableless interfaces based on different transmission technologies (IEEE 802.11a, 802.11b and 802.11g etc).

The logic part includes a processor and a memory unit which holds program algorithms. The algorithms are initialised with the data from the IO and in particular from the WLAN parts and executed by the processor. The results of data processing are cablelessly communicated by means of the WLAN part to the spatially close devices.

Each part is disposed on a separate circuit board and connected together by a hardware interface. There is the possibility of additionally adding functionalities by boards which implement that hardware interface. The hardware is implemented in a modular structure in order to standardise the addition of functionality.

The software of the system is optimised and adapted for the hardware platform and includes inter alia algorithms for affording the basic functionality of the system. The algorithms are divided up as follows:

production of cableless and encrypted data communication tunnels between the devices,

traffic shaping algorithm for detection and regulation of bandwidth bottlenecks of the WLAN interface (WLAN part),

automatic selection and configuration of the device (‘operation modes’): network element switch, network user adaptor,

distributed and redundant data holding in the overall system and access to the data, and

routing algorithm for route calculation, route maintenance and route caching.

The network element according to the invention is a novel, highly integrated hardware and software platform for cableless broadband networks, for example based on the IEEE 802.11 standards.

The hardware used is superior in terms of performance to all available network elements by several orders of magnitude. Preferably in practice the core of the network element according to the invention is formed by an RISC CPU clocked at over 500 MHz flanked by up to 64 MB flash and 128 MB RAM as well as various interface ports such as for example USB. A Linux of high stability which is suited to that use was selected as the software platform. The performance of the network according to the invention is comparable to a commercially available Intel Pentium II PC of the same clock frequency. Accordingly there is sufficient computing power available to process protocols or time-critical applications and various other applications in decentral and redundant manner without in that respect dispensing with adequate power reserves for future demands.

Two to four independent WLAN 802.11g interfaces for the first time permit cableless transmission rates of up to 216 Mbits. That is achieved for the first time by virtue of a specific mini-PCI adaptor which can be stacked in any desired fashion.

Those simultaneously guarantee a stable and high-performance connection for a large number of users. Controlled access of each individual user to any point of the network is guaranteed by transparent routing of the authorisation, authentication and metering protocols.

The small, cube-shaped and weather-resistant housing of the network element according to the invention involving the small dimensions of preferably 55×55×55 mm and the extremely low power demand makes it possible to provide network access zones at almost any location in this world, if necessary with the aid of small solar cells, if a power supply should not be available.

The production-optimised design reduces the costs of the network element according to the invention.

The network elements according to the invention group themselves automatically and cablelessly to afford an area-covering network access zone (cluster) and are thus capable of overcoming the spatial limits in terms of availability of broadband accesses by way of cable networks or central hotspots.

Up to 4 WLAN interfaces per network element according to the invention permit transmission rates of at the present time up to 216 Mbits. The implementation of a future IEEE 802.11n standard with up to 180 Mbits per interface shortly even permits a multiple thereof.

A very high degree of security in respect of data transmission is achieved by adapting and preferably using IPSEC and VPN standards (virtual private network). That affords the mobile user the security that the data can be viewed only by authorised persons or applications.

The network element according to the invention permits the setup of an area-covering network access zone of any size for WLAN networks for stationary access or also by means of roaming functionality for mobile users.

The use of network elements according to the invention permits the ‘genuine’ cableless operation of WLAN hotspots. There is no need for cabled Ethernet connections between the network elements according to the invention by virtue of the limited number of possible network accesses in order to permit roaming or other infrastructure measures.

The up to four mutually independent WLAN interfaces permit the dedicated allocation of bandwidth for for example infrastructure communication of a network element according to the invention with each other or with higher-level systems. For specific applications it is even possible to implement mixed .11g and .11a transmitting/receiving units in order to provide network access zones which overlap but which are independent of each other.

Bandwidth can be guaranteed for each network user as an absolute or percentage proportion of the respective available interfaces. Upon full expansion with good link quality of a network element according to the invention on average 2 Mbits/s gross are available to each network user.

Manufacturer-independence in respect of access and billing systems is made possible by transparent routing of authentication, authorisation, metering and roaming protocols, by means of the network element according to the invention.

Automated on-air software upgrades are possible in order to be ready for future applications and security standards.

A close network of network elements according to the invention enhances the quality of service factor as well as the performances of data services by independent reorganisation, with implement of a redundant network structure.

The network element according to the invention permits ranges of up to 400 m using omnidirectional antennae of large spread angles and up to 5000 m in the exterior region by the use of directional antennae of small spread angles. Ranges of up to 100 m can be achieved in the interior region. It is possible to achieve even still larger ranges in all exterior regions by generously waiving bandwidth.

Network Access Zone

Network elements according to the invention group themselves independently and cablelessly to afford an area-covering WLAN cluster and thus afford a network access zone.

All network elements according to the invention of a network access zone organise themselves independently because of changes in network topology, for example by virtue of the addition or removal of network elements according to the invention, always from the aspect of highest availability and redundancy of the network structure.

FIG. 25 shows by way of example a network access zone with cableless roaming access of mobile users by way of commercial laptops or PDAs with WLAN 802.11 standard hardware and the cabled access by way of the Ethernet interface of a stationary user (desktop PC). 802.11 hotspot

The network elements according to the invention are 100% downwardly compatible, with the WLAN IEEE 802.11g standard, in relation to the WLAN IEEE 802.11b standard which is most wide-spread at the present time amongst mobile users.

By virtue of the high available bandwidth of the 802.11g WLAN standard it is possible to guarantee a larger number of users a stable connection with a smaller bandwidth in terms of higher quality of service aspects. In addition it is also possible to associate user groups with quality of service classes. That allows the use of flexible billing models for mobile users.

The bandwidth of the network element according to the invention can be increased at the present time to 216 Mbits with up to four physical .11 g interfaces. Expansion to the .11 n standard with up to 180 Mbits per interface is planned in the future.

That can be used to particular advantage in relation to what are referred to as hot spots, as shown in FIG. 26.

Wireless LAN Adaptor

Stationary users (desktop PC) have access to a network access zone, as shown in FIG. 27, with the network element according to the invention, by way of a cabled Ethernet interface or by way of the integrated USB port.

The Ethernet interface additionally affords the possibility of a power supply for the network element according to the invention (power over Ethernet—PoE). That prevents ‘cable spaghetti’ between power and network cables.

All use options of the network element according to the invention, which are set forth in FIGS. 25 through 27, are available at the same time. A possible scenario would be represented accordingly as in FIG. 28:

The combination of outdoor and indoor variants of the network element affords large-area network access zones which can assume the dimensions of large cities. The use of access and billing systems (authorisation, authentication and metering) in network access zones permits access, which is controlled and transparent for the provider, for the mobile users at any points of the access zone.

A network access zone is a space of a size r³ in which cableless data transmission is possible for mobile terminals—hereinafter referred to as network users—(such as for example laptops, personal digital assistants (PDAs)) equipped with WLAN technology based on one of the IEEE 802.11 standards.

A network access zone is formed by means of network elements, wherein each network element according to the invention sets up a network access zone of the size r³. The spatial positioning of a plurality of network elements spatially enlarges the network access zone, that is to say, the spatial extent of the location-independent mobile data transmission (within the network access zone) is increased.

Furthermore, the addition of further network elements according to the invention within the network access zone increases the data throughput due to redundancy of the connections between the network elements, and thus the general stability of the network access zone.

WLAN Interface or Also Transmitting/Receiving Unit

A WLAN interface is composed of hardware components such as for example a chipset, antenna, software and so forth. It serves as a cableless communication interface between computers. Those transmitting/receiving units are already available on the market in large numbers, connected to a PC in the form of what are referred to as add-on devices, or already being in the form of an integral component part of a laptop or PDA.

WLAN Standards

A distinction is drawn between three different WLAN standards which are already available on the market: IEEE 802.11b, IEEE 802.11g and IEEE 802.11a. It is to be noted in that respect that the standards are different in terms of the data transmission rate and only 802.11b and 802.11g are compatible with each other.

Network User

These are mobile users with a laptop or personal digital assistant (PDA) with a WLAN interface. It is however also possible for stationary PC users which are equipped with a WLAN interface also to be cablelessly connected to the network.

Network Element

The network element according to the invention is a hardware and software platform for setting up network access zones. The platform comprises selectively 1, 2 or 4 transmitting/receiving units based on IEEE 802.11b, IEEE 802.11g or IEEE 802.11a standards (with selectively directed antennae and omnidirectional antennae) and is capable of setting up cableless connections to spatially closely disposed network elements according to the invention, and setting up cableless connections to network users. A network element according to the invention has a WLAN range of r³. Within that range, a cableless data communication is possible with a further network element according to the invention or a network user. The total of all network elements according to the invention affords a network access zone.

Network Access Zone

A network access zone is a space of a size r³ in which cableless data transmission is possible to any location in that space.

Data Transmission

Three different kinds of data transmission are distinguished within a network access zone involving the spatial extent of r³:

data transmission between two network users,

data transmission between a network user and a network element according to the invention, and

data transmission between a network user and any computer on the Internet.

Quality of a Connection

Quality of a connection for use for data transmission is quantified in Kbits/s or Mbits/s. An example: there is a choice of two connections. Connection 1 of a quality of 2 Mbits/s and connection 2 of a quality of 500 Kbits/s. Connection 1 is preferably selected. The quality of a connection however can also be measured in terms of the number of hops between two network elements. When establishing the quality of a connection the average SNR (signal-noise ratio) is also involved. The greater the average signal-noise ratio of a connection, the correspondingly higher is the evaluation of that connection or the metrics of a route which uses that connection.

Bandwidth

The possibility of simultaneous transmission of data packets at a time T by way of a data transmission interface. Is specified alternatively in Kbits/ or Mbits/s.

Network Traffic

The total of the routed data packets in a network element which are not intended for the ‘local’ network (for network users).

Network User Traffic

The total of the data packets in a network element which are routed for network users.

Repeater

A repeater is responsible for forwarding radio signals.

Router

A router is responsible for forwarding data packets->routing.

Internet Gateway

An interface between two networks, the network access zone and the Internet.

(Basic) Functionality of a Network Access Zone

The basic functionality of a network access zone is fulfilled precisely when each network element in that network access zone can set up a connection to each other network element in that network access zone within a period of time Z. That implicitly establishes that each network user within that network access zone can set up a connection to each other network user within that network access zone.

Stability of a Network Access Zone

The stability of a network access zone is adversely affected if the basic functionality of the network access zone is not guaranteed.

This section describes the fundamental physical (‘mechanical’) processes in a network access zone. Starting from the formation of a network access zone, to fundamental intercommunication of the network elements (connections).

A network access zone can be set up at any locations. The extent of a network access zone is the sum (superimposition) of the extent of all network elements in a network access zone. The static model respectively shows a snapshot of a network access zone without taking account of the time factor t.

Static Model

FIG. 5 shows the simplest form of a network access zone 7. A network element 1 according to the invention forms a network access zone 7 of a spatial extent r³ (three-dimensional space) and of a radius for the extent of a length r (and diameter 2r).

FIG. 6 shows an expansion stage of a network access zone 7 with two network elements 1 according to the invention. The spatial extent r³ of the network access zone 7 is increased by the addition of a further network element 1. In that respect it is to be borne in mind that expansion of the network access zone is only possible if the distance between two network elements is no greater than the radius r.

FIG. 7 shows a further expansion stage of the network access zone 7 with seven network elements 1 according to the invention. The enlargement of a network access zone 7 can be increased as desired. There is no limitation in terms of the number of network elements 1.

The spatial extent r³ of a network element 1 according to the invention can be adversely affected by existing development and building in a space (for example buildings, electromagnetic interference factors, etc). That affords a realistic scenario in respect of the spatial extent r³ of a network access zone 7, as FIG. 8 shows. A plurality of spatial connections are also possible, with the length of the radius≦r between the network elements 1. The network elements 20, 30 and 40 have multiple connections of a length≦radius r.

The network element 80 is not a full member of the network access zone as the element 80 is outside the range involving the radius length r. It is however possible to close the ‘gap’ by positioning a further network element and to link the element 80 in, as a full member of the network access zone (transit time model).

The transit time model shows the physical processes in a network access zone in the context of the time parameter t. That shows an essential property of a network access zone and the network elements thereof: spontaneous connections between two network elements are possible, in other words, upon consideration in the context of time, it will be apparent that, after an interruption in a connection between two network elements (for example due to electromagnetic interference influence), the attempt is made by both network elements to restore the connection as quickly as possible. That is shown in FIG. 9.

Each network element 1 in a network access zone 7 tries at any moment in time T to involve as many connections as possible with spatially close network elements 1 (≦length of the radius r) in order constantly to improve the stability and redundancy of the network access zone 7. Each network element 1 thus pro-actively contributes to improving the performance of the overall system—the network access zone 7.

The sum of all connections between network elements 1 in a network access zone 7 at a moment in time to is with a high level of probability not the same as the sum of all connections between network elements 1 of the same network access zone 7 at a moment in time t1 without the stability and functionality of the overall system—the network access zone—being adversely affected.

Connections Between Network Elements and Network Users

Static Model

Network users 2 can set up a cableless data connection to a network element 1 on the basis of one of the WLAN standards within the spatial extent r³ of the network access zone 7. That is irrespective of the respective location of the network user 2 (within the network access zone 7). That is shown in FIG. 10.

In that case the choice of the connection of the network element 1 is implemented on the basis of the quality of the connection; that means that connections of high quality are preferably selected. That is shown in FIG. 11.

Dynamic Model

The quality of the connections is always assessed and suitably activated in the course of time. That is of great significance in particular in connection with mobile network users.

From the point of view of the mobile network user, the example in FIG. 12 is a continuous and interruption-free connection with possibly fluctuating qualities in the connection.

Connections Between Network Elements

The following processes take place exclusively in the context of the passage of time.

Finding an Address

The respective address of the network element is found in the network access zone by means of a protocol based on ARP (address resolution protocol).

Routing of the Data Packets

A distinction is drawn between two fundamental mechanisms for permitting successful routing of data packets through the network access zone: route calculation and route maintenance. Both mechanisms can be activated as required—‘on demand’.

Route Calculation

That mechanism comes into force when a first network element 1 sends a data packet to a second network element 1 and the first network element in return receives the routing information on the basis of that mechanism. That mechanism comes into force only when a first network element 1 sends a data packet to a second network element 1 and does not yet have any routing information. To calculate the route therefore, in general terms, the neighbouring network elements are discovered by the link discovery protocol and the routing entries are propagated in the network by means of a meshing protocol. In other words, this ultimately involves dynamically setting up a routing table. The routing algorithm is preferably a shortest path algorithm.

Route Maintenance

This mechanism comes into force when a first network element 1 is already sending data packets to a second network element 1 and in that situation the first network element discovers that the routing information is no longer correct as the route is for example interrupted or the second network element 1 no longer exists. The first network element 1 will try to find another route to the second network element, possibly using that mechanism.

Route Cache

Each data packet contains all the routing information from the source to the target. Each network element which forwards a data packet to the next network element stores the routing information of the data packet in a local route cache. That allows a very fast reaction to changing routes by the entire network access zone. Defective routes which for example are interrupted (due to the failure of a network element) are replaced by alternative routes from the route cache—if available—in order to forward the packet. An alternative route is possibly found and thus no further route calculation is required. That has a considerable influence on the performance of the entire network access zone.

Data Communication

Bidirectional data communication between two network elements 1 is effected by means of mechanisms based on the despatch and receipt of IP packets.

Connections between Network Users

This represents a combination of the mechanisms of the points connections between network elements 1 and network users 2 and connections between a plurality of network elements 1. FIG. 13 shows the connection between two mobile network elements 1. At any moment in the passage of time t a data communication is possible between two mobile network users 2. From the point of view of the network user 2 this involves a continuous and interruption-free connection with possibly changing natures (qualities) of the connection.

Connections between a Network User 2 and the Internet 4

This represents a combination of the mechanisms of the points connections between network elements 1 and network users 2 and connections between a plurality of network elements 1. In that situation one or more network elements 1 take over the part as a gateway into the Internet 4. FIG. 14 shows a continuous and interruption-free connection between a network user 2 and a network element 1 which serves as a gateway into the Internet 4. It is to be noted in that respect that an optimum route is constantly selected for the data communication; the route is always selected in respect of the spatially most closely adjacent gateway on the basis of the respective position of the network user 2.

It is to be added that two physically independent network access zones 7 can be ‘connected’ together by way of the Internet 4 so that all network elements including network users within those two network access zones can be in communication. That is shown in FIG. 15.

Context-Sensitive Routing

There exists a dependency between the routing mechanisms and the demands of the network user (context). The network user is always at the focal point in terms of the demands involved and is the basis for the respective routing mechanism to come into effect. If for example a connection is wanted between a network user and the Internet, then the focus of the routing mechanism is directed to finding the spatially nearest gateway and optimising the route through the network access zone.

In the case of intercommunication between two network users the focus of the routing mechanism is directed to finding the optimum route between the network users.

Hardware Architecture

The hardware architecture of the network element according to the invention is preferably of a modular structure: there are three preferred basic components of the network element according to the invention, which represent the basic configuration:

logic board (CPU and memory) or control units 11 and data memory 15

interface board 13 (input and output interfaces such as for example Ethernet, USB and power supply), and

transmitting/receiving units 12 (2×IEEE 802.11g).

That configuration provides the entire basic functionality—comparable to a commercially available PC—. The modules are connected together by way of a defined hardware interface and thus each module is interchangeable.

In that respect it is to be noted that the maximum height and width of the boards do not exceed the size of preferably 55 mm. FIG. 16 shows a diagrammatic representation.

The housing of the network element according to the invention is preferably cube-shaped and weather-resistant. That is shown in FIG. 17. The power supply is effected alternatively by way of an external 9V power supply unit or by way of PoE (power over Ethernet)—power supply by way of the Ethernet cable.

The network element can alternatively be operated with a lithium ion accumulator which is preferably disposed in an additional cube-shaped housing (battery).

The WLAN interface board comprises two separate IEEE 802.11g chipsets and two antennae. In that respect a respective transmitting/receiving unit 12 is reserved for the network element data exchange (traffic) and network user data exchange traffic.

Software Architecture

The software architecture is optimally matched to the respective hardware configuration of the network element. Software modules for additional hardware components on the basis of the network element can be added dynamically during the running time without the overall system being adversely affected thereby.

In addition the network element ‘recognises’ the respective purpose of use as a gateway, router, DHCP server, webserver or firewall and configuring is effected ‘automatically’.

Traffic Shaping

The need for bandwidth by virtue of high data traffic between network elements or network users respectively is regulated dynamically and in an interruption-free manner by the network element according to the invention.

An example: With high network element traffic and low network user traffic, a part of the available bandwidth of the network user interface or transmitting/receiving unit is assigned to the network element transmitting/receiving unit.

Software

The processes of the interactive network element can be subdivided into an interactive part of working procedures, which is triggered by actions on the part of network users (that is to say changing settings by means of the configuration website) and an automatic part of working procedures, which is triggered by backend applications such as monitor agents, trigger agents or SNMP controllers.

From the point of view of the applications ‘automatic’ processing procedures are started as a consequence of different actions: for example parameters such as signal quality or the entries in the routing tables change. Monitor and trigger agents are implemented in order to separate from each other actions which are triggered by change events or other events and those of the actual working procedure.

In addition, an abstraction layer was provided in order to separate elementary services such as DHCP, DNS or HTTP from the application layer and thus to provide a usual interface and to parameterise those services (config manager).

Target Architecture

From the point of view of an application the network element uses a modification of the GNU/Linux system, which corresponds to a division of the system into two parts, namely the user workspace domain and the kernel workspace domain.

In addition to that basic architecture, a distinction is to be drawn between application-specific components which are in the architectural layer and reusable components between the applications which are assembled in the enterprise layer. The enterprise layer has components which are domain-specific, that is to say components which are usual for a given domain (config manager). More than one application can use components of the enterprise layer. That is shown in FIG. 18.

It should be mentioned that an application layer can be viewed as a ‘business component system’ which has the logic and intelligence of the core application of the network element according to the invention.

Basically a distinction is drawn between three stereotypes of components: what are referred to as agents, managers and controllers.

General Design Principle

The application layer comprises components which are referred to as (business) agents: agents implement business rules (activities) by using elementary services which are afforded by the managers of the enterprise layer. In general terms an agent can combine more than one service from more than one manager. Agents interleave data flows in the context of the network element according to the invention and in a system of network elements according to the invention the agents interleave individual steps comprising for example stopping, configuring and restarting elementary GNU/Linux services by the use of the config manager (enterprise layer). The reusability of agents is limited.

The enterprise layer includes what are referred to as managers: a manager provides services. A manager can use services which are offered by other managers. A controller controls the working procedure of the actions of the users, that is to say the user actions of the configuration website of the network element according to the invention.

Dynamic Model (Mechanism)

FIGS. 19 through 24 show three elementary mechanisms of the core features of the network element according to the invention:

The search for new connections (link discovery), the connection state protocol (link state protocol) which is part of the wireless infrastructure network and is physically separate from the wireless network of the network users and the roaming mechanism of the network users.

The link discovery protocol provides a media-independent mechanism in order to discover neighbours in a mobile ad hoc network and is capable of determining whether connections are unidirectional or bidirectional. In addition a connection metrics is associated with each entry in the IP address table, which is based on the average value of the average measured connection signal quality over time.

The link state protocol ensures distribution of the entries of the routing table (inclusive of the IP addresses) within the network.

The roaming mechanism of the network users permits an interruption-free and mobile wireless connection to the network according to the invention.

Preconfiguration of the Network Element

The network element is preconfigured with an IP address which is present only once, on the basis of the publicly available 32bitIPv4 address region. In addition each network element includes its own unique digital fingerprint (fingerprint or certificate) for security reasons.

Two physically separate wireless interfaces (transmitting/receiving units) provide a clear separation between the connections of the wireless network users and the wireless infrastructure connections for wireless communication between network elements. That simple method anticipates the collision of data packets from network users and the infrastructure network and guarantees a maximum in terms of available bandwidth for both networks.

Link Discovery Protocol

The most important mechanisms of the link discovery protocol are shown in FIG. 19. The transmitting/receiving unit (IP interface) of the network element periodically sends an UDP datagram message to a known port of an adjacent network element (if it can be reached wirelessly). That message is of a format as shown in FIG. 20. The information type field makes it possible for a non-discovery message to be identified as such. The message also contains a list of adjacent interface addresses by which discovery messages are received on the IP interface within a known period of time.

The list of addresses is used to ascertain bidirectional connections. A bidirectional connection is made.

The fingerprint (that is to say the authentication information 23) of the network element with the IP address 10.0.1.0 is transmitted to the ‘new’ network element in order to establish whether it is a valid network element with a certificate from the certification institution. If the certificate is valid in accordance with the certification authority the certificate of the ‘new’ network element is communicated. If the certificate of the ‘new’ network element is also valid it is possible to set up data traffic by way of the new wireless connection. In that way it is also possible to produce a virtual private network connection (VPN) between the two network elements in order securely to send data packets wirelessly.

Link State Protocol

The network element periodically sends its own link state data packets (LSP) or also connection path information 22 and connection state information 21 to each interface which participates in the protocol. The LSPs are based on the network elements and allow each network element to acquire the full topology information for the entire ad hoc network. From its topology database containing the connection state information 21 and the connection path information 22, a network element, on the basis of the principle of cost minimisation, can calculate routes to all other network elements in the ad hoc network. That is also shown in FIG. 19.

The LSPs display to each interface (each network element) on the way, which addresses their neighbours (neighbouring network elements) have. Whether and at what costs those connections occur (metrics) is also displayed.

Scalability is improved by a technique which is known as fish-eye routing. In that way, the resolution of the network card of a network element is reduced with increasing distance or increasing hop distance (hop is the number of the network elements disposed therebetween) from the network element. That is achieved in that the rate at which the LSPs move through the network is reduced with increasing distance from the source thereof.

The UDP datagram message is of a format as shown in FIG. 20. That message helps to display LSP messages. The ‘router ID’ is used to identify the network element from which the message is sent, by using its own IP address. The ‘sequence number’ is used to distinguish later LSPs from earlier ones. That field is increased if the network element sends its own LSP. The field ‘age of the data packet’ indicates the period of time in which the LSP is valid. The field ‘number of hops’ indicates how many hops the LSP travelled from the source of the message. The field ‘number of the interfaces’ indicates how many interfaces of the source (network element) take part in the protocol. The ‘external route field’ contains an item of external route information.

Roaming Mechanism of Network Users

The roaming mechanism of network users permits the user mobile access to the wireless network. In addition the mechanism also has a significance for static wireless network users because a network user close to two different network elements according to the invention would possibly like to alter his association in dependence on the signal quality (connection state information 21). That is independent of the hardware equipment of the network user. The network element must prevent an active network user connection from breaking off due to re-association.

FIGS. 21 through 23 show the mechanism as to how the interruption in the wireless connection can be prevented, whereby the network user is enabled to move within the network.

FIG. 21 shows the association of a mobile network user 2 with a network element 1 of the network. The network user 2 receives the IP configuration information by means of a DHCP service of the network element 1 (the address of the network user is part of the network user IP address region). The gateway IP address remains the same within the entire network and in addition the network user 2 also receives an IP address which is unique within the network. That therefore makes it possible for a genuine end-to-end connection to exist (that is to say user-defined end-to-end VPN tunnelling through the network).

FIG. 22 shows a roaming of a wireless network user 2.

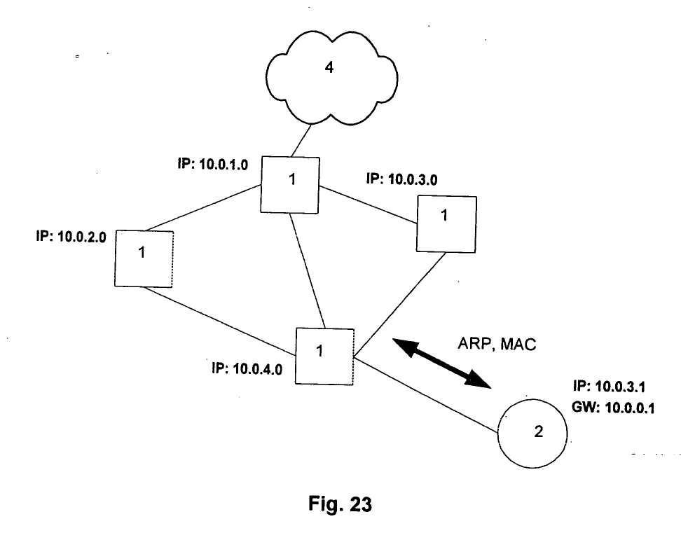

FIG. 23 shows the reconnection of a wireless network user 2 to a further network element 1. An ARP inquiry follows, which compels the network user 2 to comply with the ARP inquiries and resolve the IP address and MAC address (in particular resolution of the gateway address) for the network element which is just being associated. The new routing entry of the network element is communicated to the network by the link state protocol and the corresponding mechanisms. The network element which was originally connected to the network user then establishes that a new routing entry was signalled, which is part of its own network user IP address and notes that that IP address cannot be allocated to new wireless network users.

If a network user ‘roams’ through the network from one network element to the next, a re-association is effected from one Access Cube to the next, that is to say if a network user is in the spatial proximity of a network element, an association is effected with the network element on the MAC layer (medium access control). When using commercially available network elements (access points) the connection on the IP layer is lost upon the re-association of a network user (WLAN clients). In order to implement a change without connection interruption between the network elements (2 or more), it is necessary to find a mechanism. That was developed for the network element according to the invention and involves the following steps:

1. An association event is discovered in a network element. In other words the Access Cube observes that a ‘new’ WLAN client is associated.

2. A monitoring daemon which permanently observes the ARP table ‘notes’ a hitherto unknown IP address. It is an unknown IP address for the reason that each network element has ready a pool of IP addresses for WLAN clients and it is thus easily possible to establish whether this is a ‘local’ address originating from the pool, or an unknown external address.

3. The monitoring daemon waits until the associated MAC address appears in the ARP table.

4. As soon as the relation is made between the MAC address and the IP address, that host route is notified in the entire network.

5. The user network is notified that the IP address of the network element is the new gateway (ARP spoofing mechanism).

FIGS. 20, 21 and 22 also show that the routing entries of various network users or network users who are moving away out of the network access region of the network are not passed on by the network. The original network element which was connected to the network user can transfer the IP address 10.0.3.1 to a new network user.

Hardware Platform

The hardware has the following properties: small, in particular cube-shaped dimensions, an optionally water-resistant housing (IP67), no moving parts, low power consumption (about 3 W), an Ethernet interface, a USB host and a USB interface, power over Ethernet (IEEE 802.3af standard), 2 WLAN interfaces (RP-SMA connections), 500 MHz MIPS processors, 32 MB flash memory and 64 MB RAM, as well as IEEE 802.1x compatibility (EAP, radius).

The software platform has in particular: a link discovery protocol, a link state protocol, trigger agents, monitor agents, config web controller, config manager, DHCP services, HTTP services, DNS services, IPSEC services, SSH services, CRON services, PPPOE services (DSL), SNMP agents, Perl and a packet management system for on-air software updates and upgrades without the network element having to be re-started.

Config Web Interface

The configuration website of the network element makes it possible for preferably the most important parts of the system, that is to say routing, NAT, IPSEC, IPTABLES (firewall), MAC address filtering, DHCP services and DNS services to be parameterised.

Kernel Workspace Domain

The kernel workspace domain comprises the newest stable GNU/Linux kernel especially compiled for the network element according to the invention.

1. A network element for setting up wireless networks for wireless data exchange between network elements and/or network users, wherein the network element has a transmitting/receiving unit for wirelessly transmitting and receiving data, a control unit for controlling the processing of data and a data memory,
characterized in that the control unit is adapted to evaluate connection path information and connection state information for data exchange between network elements and/or network users in order to determine partial sections of data transmission routes and/or complete data transmission routes for transmitting or forwarding data, wherein the connection path information specifies the number of the network elements and the neighborhood relationships of the network elements of the network and the connection state information specifies the state of the connection between network elements and/or network users.

2. A network element as set forth in claim 1
characterized in that the control unit is adapted to evaluate connection state information and connection path information stored in the data memory and/or connection state information and connection path information contained in the data intended for the data exchange.

3. A network element as set forth in claim 1
characterized in that the connection path information stored in the data memory specifies the number of the network elements and the neighborhood relationships of the network elements of the entire network and the connection state information specifies the state of the connection between network elements and/or network users of the entire network.

4. A network element as set forth in claim 1
characterized in that the data memory is adapted for storage of an item of authentication information which is present only a single time for each network element and the control unit is adapted to transmit the authentication information by means of the transmitting/receiving units to other network elements and to evaluate the items of authentication information received from other network elements for checking the entitlement of the other network elements of the network for data exchange in the network.

5. A network element as set forth in claim 1
characterized in that the data memory is adapted for the storage of an item of authorization information which is unique in the network, in particular an item of address information, which is characterizing in respect of each network user and each network element in the network, and the control unit is adapted to transmit the authorization information by means of the transmitting/receiving units to other network elements and to evaluate the authorization information received from other network elements to determine at least partial sections of data transmission routes in the network.

6. A network element as set forth in claim 1
characterized by a first transmitting/receiving unit for the data exchange of network elements with each other and a second transmitting/receiving unit for data exchange between network elements and network users.

7. A network element as set forth in claim 1
characterized by coupling means for coupling the network element for data exchange with a second network, in particular a non-wireless infrastructure network like the Internet.

8. A network element as set forth in claim 1
characterized by coupling means for coupling of the network element to a plurality of different energy sources, in particular solar cells.

9. A network element as set forth in claim 7
characterized in that the coupling means for data exchange are adapted also to supply the network element with energy by means of the coupling means for data exchange, in particular by means of an Ethernet connection for a non-wireless infrastructure network.

10. A network element as set forth in claim 1
characterized by at least one transmitting/receiving unit in accordance with one or more of the standards IEEE 802.11a, IEEE 802.11b and IEEE 802.11g.

11. A network element as set forth in claim 1
characterized in that it has one or more WLAN PCI-cards in accordance with one or more of the standards IEEE 802.11a, IEEE 802.11b and IEEE 802.11g, volatile and non-volatile memories, in particular SDRAMs or flash memories, a microprocessor or microcomputer unit and/or programmable logic components, for regulating and controlling power loss and the energy sources and two antennae respectively for data of network users and network elements.

12. A method of setting up wireless networks for data exchange between network elements and/or network users comprising the steps:
exchanging and storing connection path information and connection state information of the network elements relative to each other and of the network users relative to the network elements,
evaluating the connection path information and connection state information,
exchanging data between network elements and/or network users based on the items of connection path information and items of connection state information, by dispatching data through a first network user to a network element arranged in the proximity, and
receiving the data through the network element and further dispatching the data in relation to an adjacent network element in a direction towards the addressed second network user or the addressed network user itself by way of a data transmission route ascertained from the connection state and connection path information or a partial section of a data transmission route.

13. A method as set forth in claim 12 characterized by finding network elements and network users by wirelessly receiving and emitting connection enquiries.

14. A method as set forth in claim 12
characterized by checking the authenticity of the found network elements by evaluation of a sent item of authenticity information for ascertaining the entitlement for data exchange and storage of the entitlement information ascertained therefrom.

15. A method as set forth in claim 12
characterized by the steps of transmitting, receiving, allocating and storing in the network unique authorization information, in particular address information of network elements and network users.

16. A method as set forth in claim 15 characterized by handing over network users from the transmitting/receiving region of a first network element into the transmitting/receiving region of a second network element in dependence on the connection state information and the connection path information while retaining the unique authorization information associated with the network user.

17. A method as set forth in claim 12
characterized by adding network element to the transmitting/receiving region of network elements already arranged in the network.

18. A method as set forth in claim 12
characterized by distinguishing and separating the wireless data exchange in accordance with network users and network elements, in particular by using different frequency ranges, allotting frequency channels, time multiplexing and/or different modulation methods and/or standards of wireless data transmission for data exchange between network users and data exchange only between network elements.

19. A method as set forth in claim 18
characterized by coupling a plurality of network elements to a second network, in particular a non-wireless infrastructure network like the Internet.

20. A method as set forth in claim 12
characterized by
provision of a predefined limited number of items of authorization information (24) for network users, which is the same in all network elements,
the detection of an association event by a network element, which indicates that a network user is within the transmission/reception range of a network element,
comparison of the communicated authorization information (24) with the predefined known items of authorization information,
evaluation of the comparison to ascertain whether this is an external network user (2) or a network user who is already known,
assignment of an item of authorization information when an external network user has been ascertained,
communicating the connection path and/or connection state information related to the network user to the network elements of the network, and
communicating an item of authorization information to the network user, which is characteristic of the network, in particular address information for data transmission.

21. A network having network elements as set forth in claim 1 for setting up wireless networks for network users according to a method as set forth in one of claims 12 through 19, wherein the data exchange between two or more network users is always effected at least by means of a network element and on the basis of the connection state and the connection path information.

22. A network as set forth in claim 21
characterized in that the spatial distance of the network elements is substantially less than the range of the transmitting/receiving units of the network elements.

23. A network as set forth in claim 21
characterized in that inter-related data can be stored distributedly in the data memories of a plurality of network elements.
